(19) United States
(12) Patent Application Publication
(10) Pub. No.: US 2012/0206193 A1
(43) Pub. Date: Aug. 16, 2012

(54) INTERNAL POWER SUPPLY VOLTAGE GENERATION CIRCUIT

(76) Inventor: Masakazu SUGIURA, Chiba-shi (JP)

(21) Appl. No.: 13/370,712

(22) Filed: Feb. 10, 2012

(30) Foreign Application Priority Data
Feb. 16, 2011 (JP) 2011-031295

(51) Int. Cl. G05F 3/02

(52) U.S. Cl. 327/541

(57) ABSTRACT

Provided is an internal power supply voltage generation circuit, with which a through current can be prevented from being excessive due to manufacturing fluctuations during the operation of a logic circuit, to thereby suppress current consumption. Provided is an internal power supply voltage generation circuit for generating an internal power supply voltage at an internal power supply terminal and supplying the internal power supply voltage to a logic circuit, the internal power supply voltage generation circuit including: a transistor having a source follower configuration for outputting a voltage applied to a gate thereof; and a current limiting circuit for limiting a maximum current of the transistor having the source follower configuration for outputting the voltage applied to the gate thereof, to thereby suppress a maximum current supplied to the logic circuit and suppress current consumption.

### RELATED APPLICATIONS

This application claims priority under 35 U.S.C. §119 to Japanese Patent Application No. 2011-031295 filed on Feb. 16, 2011, the entire content of which is hereby incorporated by reference.

### BACKGROUND OF THE INVENTION

1. Field of the Invention

The present invention relates to an internal power supply voltage generation circuit for generating an internal power supply voltage at an internal power supply terminal and supplying the internal power supply voltage to a logic circuit.

2. Description of the Related Art

A conventional internal power supply voltage generation circuit is described. FIG. 7 is a circuit diagram illustrating the conventional internal power supply voltage generation circuit.

A saturation-connected transistor 801 having a source follower configuration decreases a power supply voltage VDD applied to a gate thereof to an internal power supply voltage DVDD, and outputs the internal power supply voltage DVDD. With the internal power supply voltage DVDD and a ground voltage VSS, a logic circuit 802 operates.

The logic circuit 802 is a circuit that outputs a signal of High level or Low level and is, for example, an oscillation circuit or a counter for counting the number of input pulses.

During the operation of the logic circuit 802, the internal power supply voltage DVDD is maintained to a substantially constant value, and hence the logic circuit 802 can operate stably.

During the operation of the logic circuit 802, current consumption greatly depends on a through current, specifically the magnitude of the operating voltage of the logic circuit 802. When the power supply voltage for the logic circuit 802 decreases from the power supply voltage VDD to the internal power supply voltage DVDD, the through current decreases correspondingly during the operation of the logic circuit 802 (see, for example, Japanese Patent Application Laid-open No. Hei 08-018339).

In the conventional technology, however, because a threshold value of the transistor 801 has manufacturing fluctuations, even if a gate voltage having a constant value is applied to the transistor 801, the internal power supply voltage DVDD fluctuates. Accordingly, there has been a problem that it is difficult to maintain the internal power supply voltage DVDD constant. For example, when the internal power supply voltage DVDD fluctuates to be higher, the through current becomes excessive during the operation of the logic circuit 802, and the current consumption increases. That is, the through current that flows during the operation of the logic circuit 802 to which the internal power supply voltage DVDD is supplied depends on the threshold value of the transistor 801 and hence the current consumption increases.

### SUMMARY OF THE INVENTION

The present invention has been made for solving the above-mentioned problem, and realizes an internal power supply voltage generation circuit with which a through current can be prevented from being excessive due to manufacturing fluctuations during the operation of a logic circuit to which an internal power supply voltage is supplied.

The present invention provides an internal power supply voltage generation circuit for generating an internal power supply voltage from a power supply voltage input to a power supply terminal and supplying the internal power supply voltage to a logic circuit, the internal power supply voltage generation circuit including: a MOS transistor having a source follower configuration for outputting a voltage applied to a gate thereof; and a current limiting circuit for limiting a maximum current of the MOS transistor.

According to the present invention, the internal power supply voltage generation circuit can be provided, with which the through current can be prevented from being excessive due to manufacturing fluctuations during the operation of the logic circuit to which the internal power supply voltage is supplied, and current consumption can be suppressed as well.

Besides, the internal power supply voltage has no excessive voltage fluctuations during the operation of the logic circuit, and hence the logic circuit can operate stably.

### BRIEF DESCRIPTION OF THE DRAWINGS

In the accompanying drawings:

FIG. 1 is a block diagram illustrating an internal power supply voltage generation circuit according to the present invention;

FIG. 2 is a circuit diagram illustrating an example of a current limiting circuit of FIG. 1;

FIG. 3 is a circuit diagram illustrating another example of the current limiting circuit of FIG. 1;

FIG. 4 is a circuit diagram illustrating still another example of the current limiting circuit of FIG. 1;

FIG. 5 is a block diagram illustrating another example of the internal power supply voltage generation circuit according to the present invention;

FIG. 6 is a block diagram illustrating still another example of the internal power supply voltage generation circuit according to the present invention; and

FIG. 7 is a configuration diagram of a conventional internal power supply voltage generation circuit.

### DETAILED DESCRIPTION OF THE PREFERRED EMBODIMENT

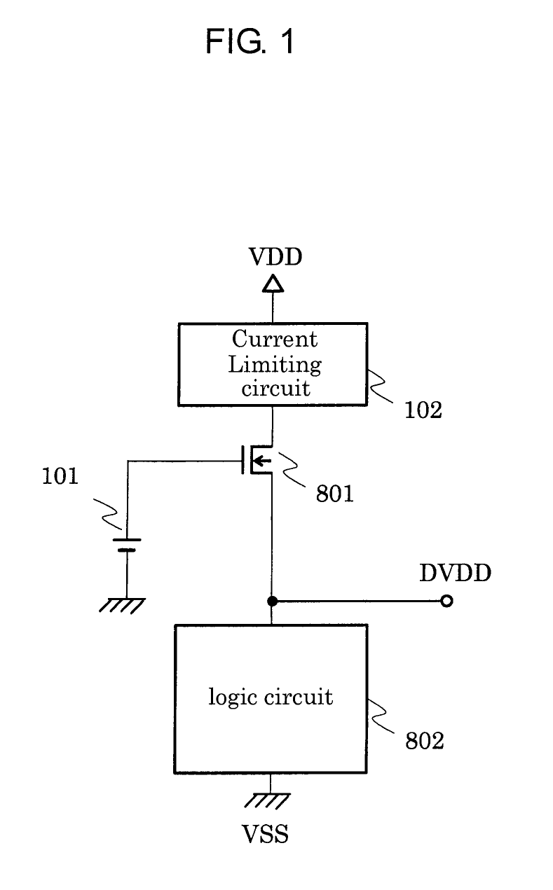

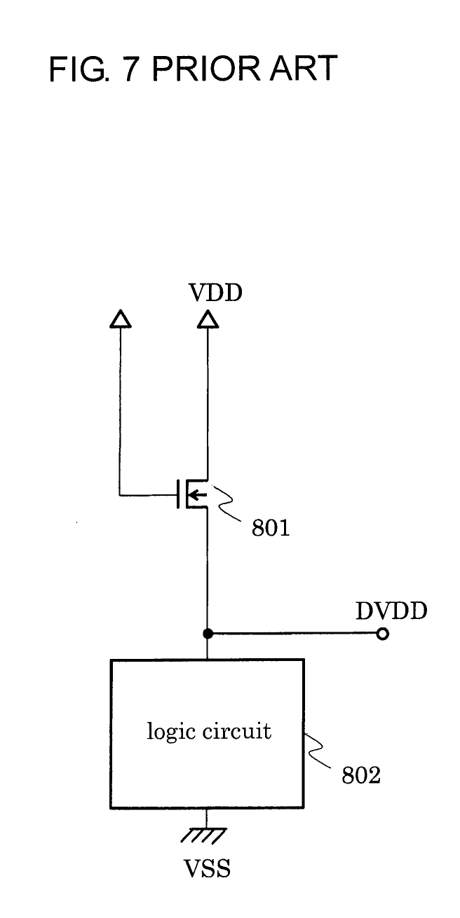

FIG. 1 is a block diagram illustrating an internal power supply voltage generation circuit according to an embodiment of the present invention. The difference between FIG. 1 and FIG. 7 resides in that a voltage source 101 for applying a gate voltage of the transistor 801 is provided and a current limiting circuit 102 is provided on the High side of the transistor 801.

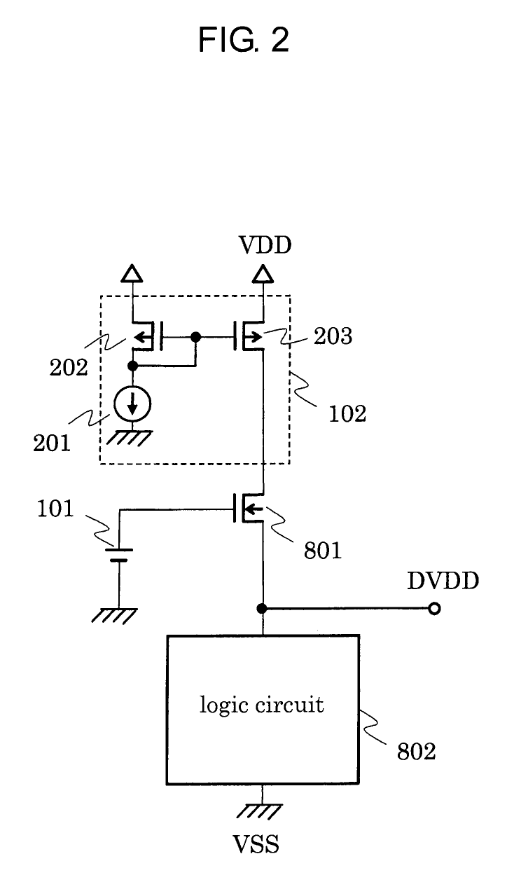

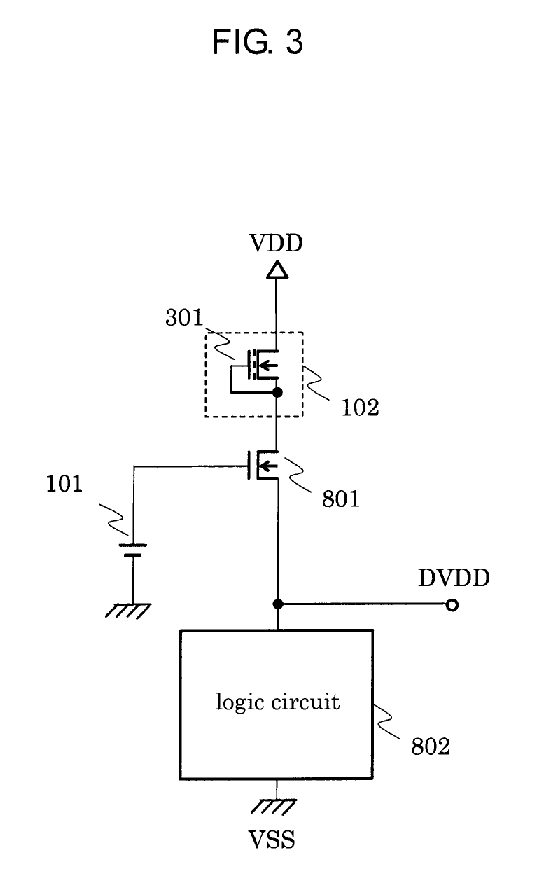

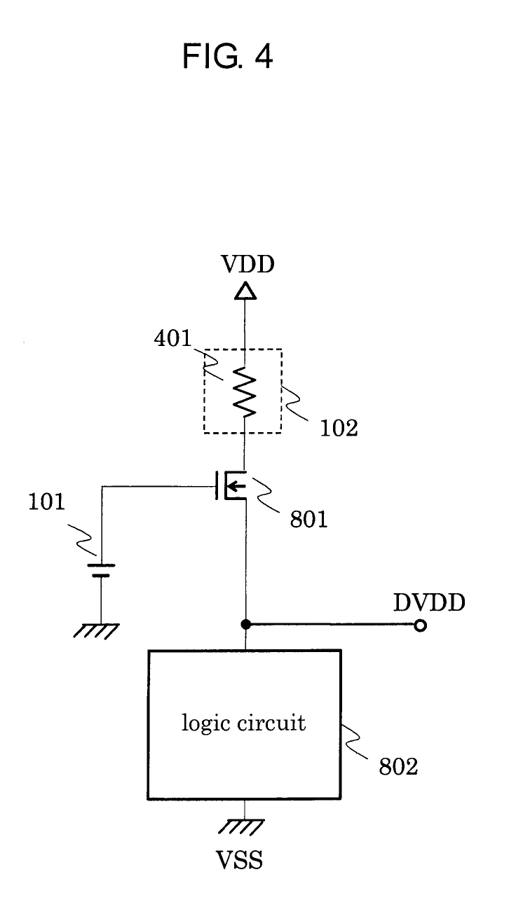

The current limiting circuit 102 has a function of limiting a maximum value of a current driven by the transistor 801. The current limiting circuit 102 is formed of, for example, a current mirror circuit as illustrated in FIG. 2, a depletion mode transistor as illustrated in FIG. 3, or a resistor as illustrated in FIG. 4.

Hereinafter, an operation of the internal power supply voltage generation circuit according to this embodiment is described.

When the logic circuit 802 operates, a through current flows therein. The voltage source 101 applies an appropriate voltage to a gate of the transistor 801 to control the transistor 801 so that an internal power supply voltage DVDD does not become excessive. In the case where, for example, a constant voltage circuit for generating a voltage by causing a current to flow into a saturation-connected transistor is used as the voltage source 101 under the assumption that the current is reduced, current consumption of the internal power supply voltage generation circuit can be suppressed.

As described above, the value of the through current generated during the operation of the logic circuit 802 depends on the magnitude of the operating voltage thereof. If a threshold voltage of the transistor 801 fluctuates to be smaller, the internal power supply voltage DVDD becomes larger. The logic circuit 802 uses the internal power supply voltage DVDD as the operating voltage thereof and therefore requires a large through current as a drive current of the transistor 801.

However, with the current limiting circuit 102 provided, the transistor 801 cannot drive a through current as required. As a result, the internal power supply voltage DVDD decreases. Accordingly, the operating voltage of the logic circuit 802 decreases, and the value of the through current decreases. Then, the internal power supply voltage DVDD decreases to a value equal to a current value which is limited by the current limiting circuit 102.

Through the operation described above, it is possible to avoid the state in which an excessive through current flows through the logic circuit 802.

Further, in the operation described above, an appropriate value of the voltage of the voltage source 101 is applied to the gate of the transistor 801 to control the transistor 801 so that the internal power supply voltage DVDD does not become excessive. Therefore, during the operation of the logic circuit 802, the internal power supply voltage DVDD is free from excessive voltage fluctuations, and hence the logic circuit 802 can operate stably.

According to the internal power supply voltage generation circuit of this embodiment having the configuration described above, during the operation of the logic circuit to which the internal power supply voltage is supplied, a through current can be prevented from being excessive due to manufacturing fluctuations, and hence current consumption can be suppressed. Besides, during the operation of the logic circuit, the internal power supply voltage has no excessive voltage fluctuations, and hence the logic circuit can operate stably.

The internal power supply voltage generation circuit of this embodiment described above is not provided with a current source for supplying a current to the transistor 801 all the time, but may be provided with the current source. Note that, if the current to be supplied to the transistor 801 all the time can be replaced with a leakage current of the logic circuit 802, then it is not necessary to provide the current source for supplying the current to the transistor 801 all the time.

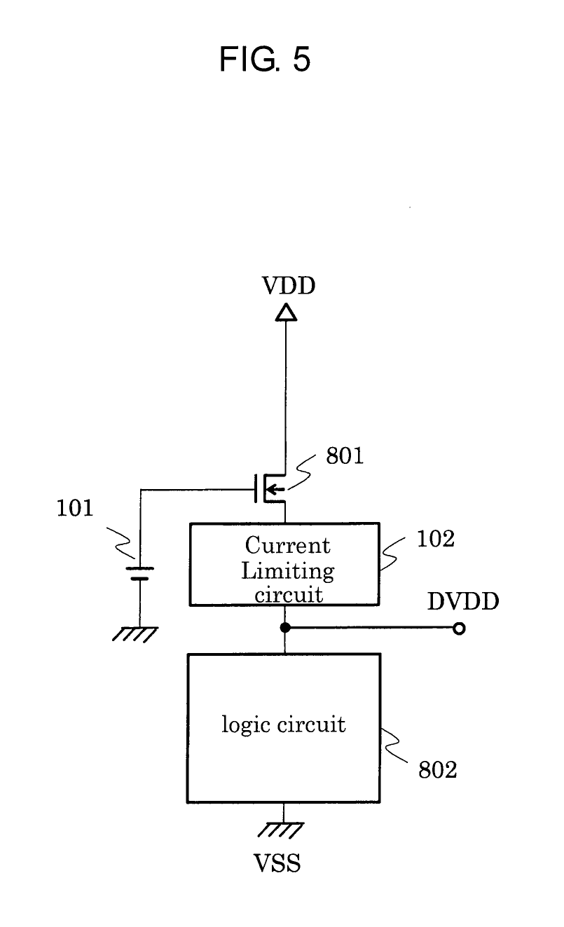

In the internal power supply voltage generation circuit of this embodiment described above, the current limiting circuit 102 is provided on the High side of the transistor 801. However, the same effect can be obtained even when the current limiting circuit 102 is provided on the Low side of the transistor 801 as illustrated in FIG. 5.

Hereinafter, an operation of the internal power supply voltage generation circuit in another configuration example in which the current limiting circuit 102 is formed of a depletion mode transistor as illustrated in FIG. 3 is described. When the internal power supply voltage DVDD increases, a threshold voltage of the depletion mode transistor increases because a back gate voltage thereof drops, and hence the current is limited to be smaller. Accordingly, there is an advantage that, under the condition where a through current becomes larger, that is, the condition where the internal power supply voltage DVDD becomes larger, the current can be limited more effectively.

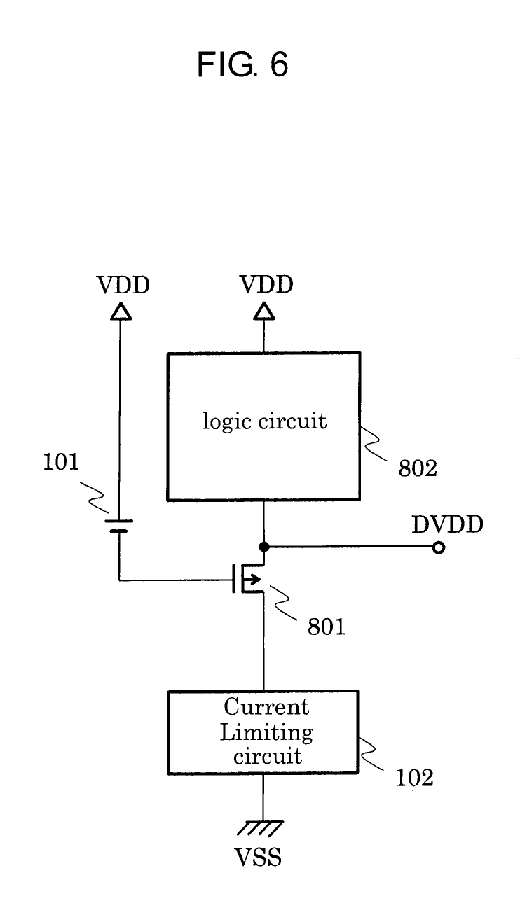

Further, the internal power supply voltage generation circuit of this embodiment described above has a configuration in which an N-type transistor is used as the transistor 801. However, the same effect can be obtained even with a P-type transistor. FIG. 6 illustrates a block diagram of the internal power supply voltage generation circuit in which a P-type transistor is used as the transistor 801.

Note that, in the above description, the transistor 801 is a MOS transistor, but it should be understood that the same effect can be obtained even when the transistor 801 is another kind of transistors such as a bipolar transistor. In other words, the transistor 801 only needs to output the internal power supply voltage DVDD that follows a voltage input to an input terminal (such as a gate and a base). For example, in the case of MOS transistors, there is an advantage of low consumption because no gate current basically flows. Alternatively, for example, in the case of bipolar transistors, there is an advantage of increased speed because a higher speed operation is possible as compared to the MOS transistors.

Further, in the internal power supply voltage generation circuit of this embodiment described above, the current limiting circuit 102 has the configuration illustrated in FIG. 2, 3, or 4, but the same effect can be obtained as long as the current limiting circuit 102 has the same function.

What is claimed is:

1. An internal power supply voltage generation circuit for generating an internal power supply voltage from a power supply voltage input to a power supply terminal and supplying the internal power supply voltage to a logic circuit, the internal power supply voltage generation circuit comprising:
an output transistor for outputting a voltage which follows a voltage applied to an input terminal; and
a current limiting circuit for limiting a maximum current of the output transistor.

2. An internal power supply voltage generation circuit according to claim 1, wherein the output transistor comprises a MOS transistor.

3. An internal power supply voltage generation circuit according to claim 1, wherein the output transistor comprises a bipolar transistor.

4. An internal power supply voltage generation circuit according to claim 1, wherein the current limiting circuit includes a transistor.

5. An internal power supply voltage generation circuit according to claim 4, wherein the current limiting circuit comprises a current mirror circuit including the transistors.

6. An internal power supply voltage generation circuit according to claim 4, wherein the transistor of the current limiting circuit comprises a depletion mode MOS transistor.

7. An internal power supply voltage generation circuit according to claim 1, wherein the current limiting circuit includes a resistor.

8. An internal power supply voltage generation circuit according to claim 1, wherein the current limiting circuit is provided on a High side of the output transistor.

9. An internal power supply voltage generation circuit according to claim 1, wherein the current limiting circuit is provided on a Low side of the output transistor.
